(19) United States
(12) Patent Application Publication
(10) Pub. No.: US 2004/0055188 A1
(43) Pub. Date: Mar. 25, 2004

(54) Greeting card with date-indicating decal for application to calendars

(76) Inventor: Patricia M. Dolan-King, Rancho Santa Fe, CA (US)

Correspondence Address: Mayer Fortkort and Williams, 251 North Avenue West, 2nd Floor, Westfield, NJ, 07090, US

(21) Appl. No.: 10/255,464

(22) Filed: Sep. 25, 2002

(51) Int. Cl. G09F 3/10

(52) U.S. Cl. 40/124.03; 40/638

(57) ABSTRACT

A method and greeting card are provided by which decal technology may be employed to effectively and accurately remind an invitation recipient of the date and time of the event.

### FIELD OF THE INVENTION

The present invention relates to greeting cards, and more particularly to greeting cards with removable decals.

### BACKGROUND OF THE INVENTION

Various greeting cards exist in the prior art, and many of these are employed as invitations, i.e., to invite one or more persons to a given event on a particular date. Moreover, many current greeting cards, particularly those designed, manufactured, and sold, for children, employ stickers or decals therein or thereon.

### SUMMARY OF THE INVENTION

The present invention overcomes the disadvantages of the prior art. In particular, the invention provides a method and greeting card by which decal technology may be employed to effectively and accurately remind the recipient of the invitation of the date and time of the event they were invited to.

In one aspect, the invention is directed towards a greeting card for indicating a date. The greeting card includes a card, the card containing a first set of information about an event occurring on at least one date. The card further includes a removable decal, adhesively attached via a first adhesive to the card, the decal containing a second set of information on one side corresponding to the first set of information. The decal has a second adhesive on a side of the decal opposite the side containing the second set of information, at least the second adhesive remaining on the decal when the decal is removed from the card. The decal is structured and configured to be removed from the card and adhesively disposed on a calendar, whereby at least the date of the event is indicated on the calendar.

Implementation of the invention may include one or more of the following. At least one of the first information or the second information may be in written, aural, or drawn or pictoral form. At least one of the first adhesive or the second adhesive may include a gummed substance, and the first and second adhesives can be the same. The card may have mounted thereon, via the first adhesive, a waxed paper, and the waxed paper may be attached to the decal via the second adhesive. The card may be a bifold card, a trifold card, a postcard, etc. The card, or decal, or both, may include a memory and a speaker or a microphone. The first set of information, the second set of information, or both, may include a date, time or a location of the event. The second set of information may be a shape of the decal, and the shape may be an arrow, a rectangle, a square, a bubble-shape, and so on. The decal may have a dimension of less than about 1″. The first adhesive is a friction-fit or insertion of the decal into a slot of the card. The memory may be capable of storing data corresponding to the first or second information in a format selected from the group consisting of: mp3, CD audio, RealAudio, Windows Media File, or combinations of the above. The decal may have substantially the same areal extent as the waxed area.

In another aspect, the invention is directed towards a method of making a greeting card for indicating a date. The method includes providing a card; disposing in or on the card a first set of information about an event occurring on at least one date; providing a decal, the decal containing a second set of information corresponding to the first set of information; disposing a second adhesive on a side of the decal opposite the side containing the second set of information; and mounting the decal to the card via a first adhesive.

Implementations of the invention may include one or more of the following. The disposing of the first set of information may include printing the first set of information on the card. The method may further include disposing a waxed area on the card, wherein the mounting includes disposing the decal on the waxed area, and wherein the first adhesive is the same as the second adhesive. The method may further include disposing a waxed paper on the card, wherein the mounting includes disposing the waxed paper on the card via the first adhesive. The method may further include mounting the decal on the waxed paper via the second adhesive. The first or second adhesives, or both, may be a gummed substance. The method may further include writing or printing at least one of the first information or the second information. The method may further include encoding at least one of the first information or the second information in an aural form. The method may further include drawing or picturing at least one of the first set of information or the second set of information. The method may further include folding the card into a bifold or trifold card. The method may further include disposing within the card, or the decal, or both, a memory and a speaker and/or a microphone. The method may further include disposing within the first set of information, the second set of information, or both, a date, time, or location of the event. The method may further include indicating a date of the event within the second set of information by shaping the decal in a definite pattern such as an arrow. The method may further include mounting the decal to the card which may in turn include inserting or friction-fitting the decal into a slot of the card. The method may further include shaping the decal to have substantially the same areal extent as the waxed area or waxed paper.

Advantages of the invention may include one or more of the following. Dates of events can be especially conveniently indicated on a wall-type or other such calendar, such as on an agenda or planner or desk calendar. Dates of events can be more accurately kept record of, since the originator of the event and date may be the same person who is responsible for placing the date on the decal, for later placement on a calendar.

Other advantages will be apparent from the description that follows, including the figures and the claims.

### BRIEF DESCRIPTION OF THE DRAWINGS

FIG. 1 is a schematic perspective view of a greeting card according to a first embodiment of the invention.

FIG. 2 is a view of a wall-type calendar showing a decal according to the first embodiment in-use.

FIG. 3 is a schematic perspective view of a greeting card according to a second embodiment of the invention.

FIG. 4 is a view of a wall-type calendar showing a decal according to the second embodiment in-use.

FIG. 5 is a schematic perspective view of a greeting card according to a third embodiment of the invention.

FIGS. 6 and 7 are exploded side views of two embodiments of a mounting scheme according to embodiments of the invention.

FIG. 8 is a side view of an embodiment of a mounting scheme according to the invention.

### DETAILED DESCRIPTION OF THE PREFERRED EMBODIMENTS

Definitions

“Written Form” means, for example, information which is printed, typed, written by hand, or otherwise notated on a card or decal using words.

“Aural Form” means, for example, information which is present on a card or decal and may be “read” by listening to playback by a speaker. The information may be encoded in a memory in various formats for playback. The information may either be encoded during manufacturer of the card or may be encoded by the user employing a microphone.

“Drawn or Pictoral Form” means, for example, information which is depicted by printing or otherwise notating on a card or decal using pictures or other non-literary devices to communicate information.

“First Adhesive” means, for example, a glue, gum, or other such sticky or tacky substance. The term is also used to refer to methods of adhering decals to cards such as by insertion of the decal into a slot in the card.

“Second Adhesive” means, for example, a glue, gum, or other such sticky or tacky substance. The term is also used to refer to the disposal of a decal, on which an adhesive or other gummed substance has been placed, on a waxed surface or a waxed paper.

“First Set of Information” or “first information” means, for example, information about an event such as its date, time, response information, location, number of attendees allowed, etc.

“Second Set of Information” or “second information” means, for example, information about an event such as its date, time, response information, location, number of attendees allowed, etc. The term is also used to refer to information about an event that may be communicated by virtue of a characteristic of the decal. The characteristic of the decal may be, for example, its shape or color. In particular, the decal's shape may be an arrow and the decal may be used to point to a particular date on a wall-type calendar.

“Waxed” means, for example, a surface, which may be on the card or on a separate paper, on which an adhesive may be disposed, and then removed, without loss of adhesiveness. For example, an adhesive decal may be disposed on a waxed paper, with the adhesive facing the paper, and then later the paper may be removed without substantial loss of the adhesive from the decal. In this way, the decal may be adhered to another surface. Note that the presence of “wax” per se is not necessarily required to meet this definition.

“Gummed” means, for example, a sticky or tacky surface, such as one with an adhesive disposed thereon. The adhesive may be, for example, a wet or dry adhesive.

“Bifold” means, for example, a card that is folded once.

“Trifold” means, for example, a card that is folded twice.

“Postcard” means, for example, a card that is not folded.

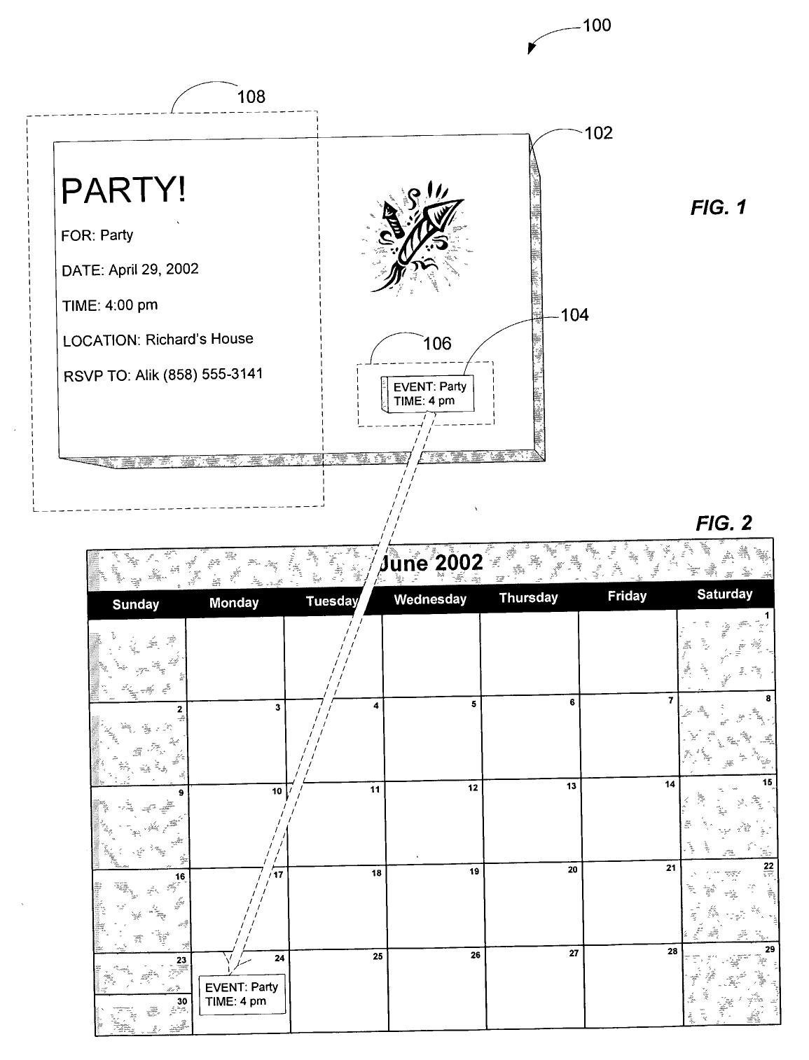

Referring to FIG. 1, a greeting card according to an embodiment of the present invention is shown in schematic form. The greeting card includes a card 102. The card 102 may have various designs thereon, and may include at least a first set of information 108. A decal 104 is disposed on the card 102, the decal 104 including a second set of information 106 that corresponds to the first set of information 108. For example, the first set of information 108 may include complete details of an event, such as time, date, location, etc., and the second set of information 106 may include a corresponding subset of this information, i.e., enough to act as a reminder or to conjure up a memory of the first set of information 108. The decal 104 is removably attached to the card 102. In this way, the decal 104 may be removed from the card 102 and placed on a wall-type calendar as shown in FIG. 2, e.g., at a location corresponding to an event date.

The first or second sets of information may include data in written or printed form, by either hand-writing or computer-generated, or other methods as are known in the art. The first or second sets of information may also include information in aural form, as will be described below. The first and second sets of information may also include pictures, drawings, or other pictorial forms of information.

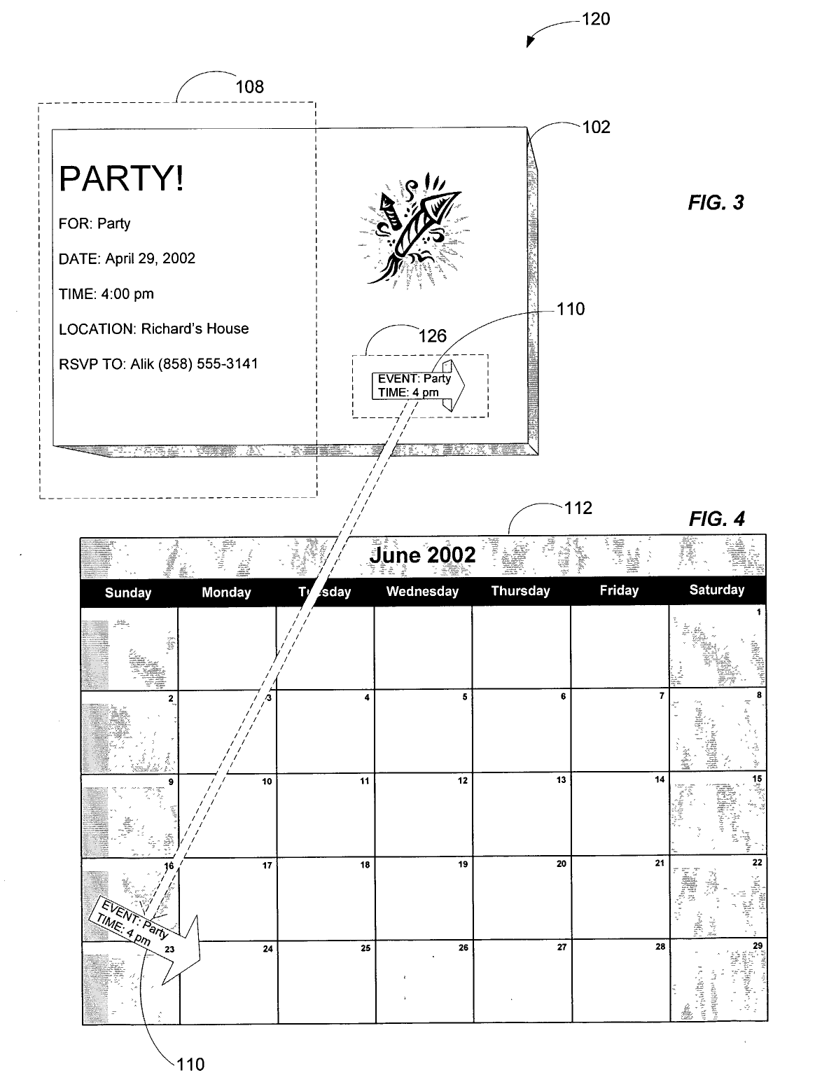

Referring now to FIG. 3, an alternative embodiment of a greeting card 120 is shown. The greeting card 120 may employ features similar to the embodiment of FIG. 1, to wit, a first set of information 108 and a card 102. However, in this embodiment, the decal 110 contains a second set of information 126. The second set of information 126 may include similar details to the second set of information 106 in the embodiment of FIG. 1, but the second set of information 126 may also include information indicated by the shape of the decal 110. In the embodiment of FIG. 3, the shape is an arrow. This arrow may then be used to point to a particular date on a wall-type calendar 112, shown in FIG. 4. In FIG. 4, this date is Apr. 29, 2002. Of course, it will be clear to one of skill in the art, given this teaching, that the arrow or other indicator may be oriented in many directions in order to convey this same information. Other shapes can be advantageously used also, if desired, as will be recognized by one of skill in the art. Suitable shapes may include, e.g., bubbles, squares, rectangles, etc.

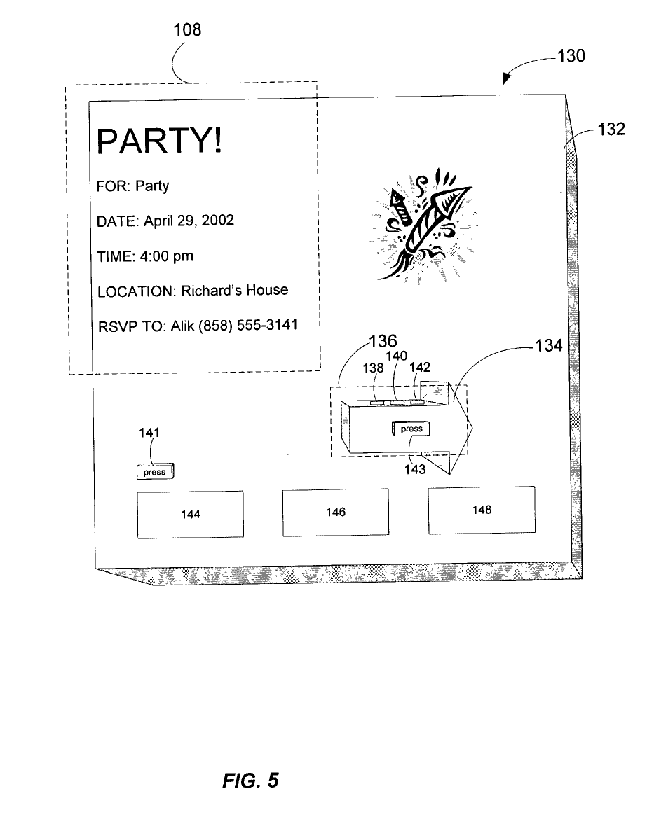

Referring to FIG. 5, an embodiment of the invention is shown in which aural reminders may be featured. In particular, a greeting card 130 is shown having a card 132. The card 132 has a first set of information 108, as do the earlier embodiments. The card 132 has a decal 134 removably attached to the same as well. The card 132, or the decal 134, or both, has aural elements disposed thereon or therein. For example, the card 132 is shown in FIG. 5 as having an optional microphone 144, a memory 146, and a speaker 148. Similarly, the decal 134 is shown in FIG. 5 as having an optional microphone 138, a memory 140, and a speaker 142. Only the memory and speaker components are required. Of course, the speaker may be replaced if desired with an optical display that blinks or performs other such functions as may be necessary to remind the user of an event. The microphone is necessary if the user wishes to customize the reminder to a particular event. However, in the case where an event may be described by a generic phrase, such as “birthday party”, the microphone may be omitted and the generic phrase encoded into the memory at the time of manufacture. In these cases, push buttons 141 and 143 are provided to allow the user to initiate message playback when desired. The memory may contain the event data in aural form in a number of formats, such as mp3, cd-audio, windows media file, etc.

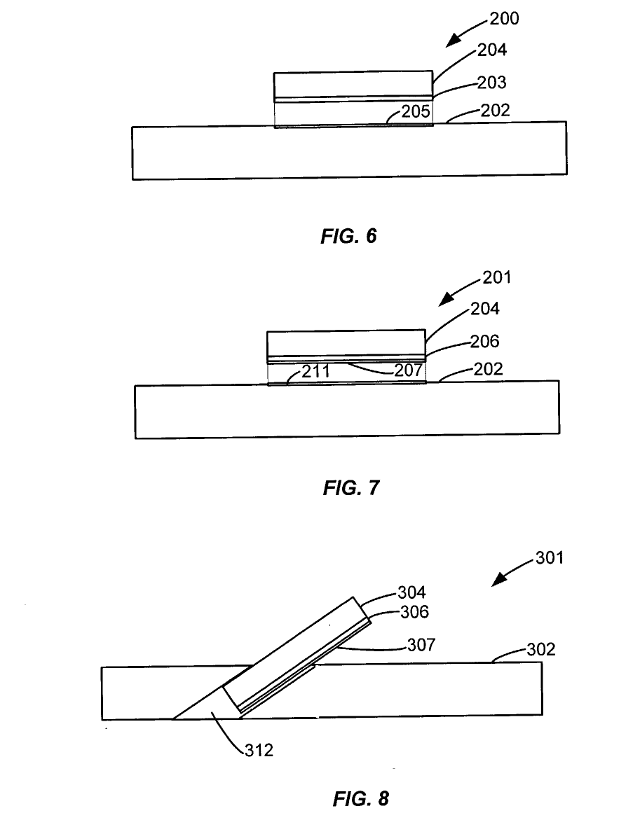

Referring now to FIG. 6, an embodiment of an attachment scheme of a decal to a card, resulting in a greeting card 200, is shown. A card 202 is shown having a waxed area 205 disposed thereon. The waxed area 205 may be fabricated during manufacture of the card 202 or thereafter. In any case, the waxed area 205 forms a given area on the card 202, and may be integral with the card 202 or may be a separate strip that is adhered thereto.

The greeting card 200 also has a decal 204 designed to be removably attached to the greeting card 200 in substantially the same area as the waxed area 205. The decal 204 further has a first adhesive 203 disposed thereon, the first adhesive 203 on the same side of the decal 204 as the side facing waxed area 205. In this case, only one adhesive is used in the construction of the greeting card 200, and thus this first adhesive is essentially the same as the second adhesive.

The first adhesive 203 attaches the decal 204 to the waxed area 205. The waxed area 205 ensures that, upon removal of the decal 204 from the card 202, a substantial amount of the first adhesive 203 remains on the decal 204 so that the decal 204 may effectively adhere to the wall-type calendar. The decal may have a substantial areal dimension of less than about 1″ in order to fit on most wall-type calendars without unduly blocking other entries on the calendar.

Referring now to FIG. 7, an embodiment of a greeting card 201 is shown having a card 202 and a decal 204. The card 202 has a first adhesive 211 disposed thereon, this first adhesive 211 employed to adhere the decal 204 to the card 202. The decal 204 has a gummed area, or second adhesive, 206 disposed thereon, this second adhesive 206 covered by a removable strip 207. The removable strip may be, e.g., a waxed paper. The removable strip 207, and thus the decal 204 by virtue of the second adhesive 206, is thus adhered in a removable fashion to the card 202. Upon removal of the decal 204 from the card 202, and the removal of the removable strip 207 from the decal, the decal 204 may be effectively adhered to the wall-type calendar.

Referring now to FIG. 8, an embodiment of a greeting card 301 is shown. The greeting card 301 includes a card 302 with a slot 312 formed therein, this slot thus being a first “adhesive” as that term is used herein. The greeting card 301 also has a decal 304, the decal to be inserted into the slot 312. The decal 304 has a second adhesive 306 disposed thereon, this second adhesive 306 covered by a removable strip 307. The removable strip 307, and thus the decal 304 by virtue of the second adhesive 306, is thus adhered in a removable fashion to the card 302.

The decal 304 may thus be adhered to the card 302 in a friction-fit manner.

Upon removal of the decal 304 from the card 302, and the removal of the removable strip 307 from the decal, the decal 304 may be effectively adhered to the wall-type calendar.

In any of the embodiments above, the decal may have substantially the same areal extent as the waxed area or waxed paper. It will be understood that the above description of a GREETING CARD WITH DATE-INDICATING DECAL FOR APPLICATION TO WALL CALENDARS has been with respect to particular embodiments of the invention. While this description is fully capable of attaining the objects of the invention, it is understood that the same is merely representative of the broad scope of the invention envisioned, and that numerous variations of the above embodiments may be known or may become known or are obvious or may become obvious to one of ordinary skill in the art, and these variations are fully within the broad scope of the invention. For example, the invention may be embodied in a number of types of greeting cards, including postcards, bifold cards, trifold cards, and so on. Further, the decal may be removable from the card in a perforated or so-called “punch-out” fashion. And while the invention has been particularly described with respect to a wall-type calendar, it may well be implemented in the context of a desk calendar, a planner, an agenda, or other such calendars. Accordingly, the scope of the invention is to be limited only by the claims appended hereto, and equivalents thereof. In these claims, a reference to an element in the singular is not intended to mean “one and only one” unless explicitly stated. Rather, the same is intended to mean “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present invention is intended to be dedicated to the public regardless of whether the element, component, or method step is explicitly recited in the claims. No claim element herein is to be construed under the provisions of 35 U.S.C. §§112, ¶6, unless the element is expressly recited using the phrase “means for”.

What is claimed is:

1. A greeting card for indicating a date, comprising:
a card, the card containing a first set of information about an event occurring on at least one date; and
a removable decal, adhesively attached via a first adhesive to said card, the decal containing a second set of information on one side corresponding to the first set of information, the decal having a second adhesive on a side of the decal opposite the side containing the second set of information, at least the second adhesive remaining on the decal when the decal is removed from the card, and the decal structured and configured to be removed from said card and adhesively disposed on a calendar, whereby at least the date of the event is indicated on the calendar.

2. The greeting card of claim 1, wherein at least one of the first information or the second information is in written form.

3. The greeting card of claim 1, wherein at least one of the first information or the second information is in aural form.

4. The greeting card of claim 1, wherein at least one of the first information or the second information is in drawn or pictoral form.

5. The greeting card of claim 1, wherein at least one of the first adhesive or the second adhesive includes a gummed substance.

6. The greeting card of claim 1, wherein the card includes a waxed area, and the first adhesive is the same as the second adhesive.

7. The greeting card of claim 1, wherein the card has mounted thereon, via the first adhesive, a waxed paper, and the waxed paper is attached to the decal via the second adhesive.

8. The greeting card of claim 1, wherein the card is a bifold card.

9. The greeting card of claim 1, wherein the card is a trifold card.

10. The greeting card of claim 1, wherein the card is a postcard.

11. The greeting card of claim 3, wherein the card, or decal, or both, include:
a memory; and
a speaker.

12. The greeting card of claim 11, wherein the card, or decal, or both, include a microphone.

13. The greeting card of claim 1, wherein the first set of information, the second set of information, or both, includes a date of the event.

14. The greeting card of claim 13, wherein the first set of information, the second set of information, or both, further includes a time or a location of the event.

15. The greeting card of claim 1, wherein the second set of information includes a shape of the decal.

16. The greeting card of claim 15, wherein the shape is an arrow.

17. The greeting card of claim 1, wherein the decal has a dimension of less than about 1″.

18. The greeting card of claim 1, wherein the first adhesive is a friction-fit or insertion of the decal into a slot of the card.

19. The greeting card of claim 11, wherein the memory is capable of storing data corresponding to the first or second information in a format selected from the group consisting of: mp3, CD audio, RealAudio, Windows Media File, or combinations of the above.

20. The greeting card of claim 8, wherein the decal has substantially the same areal extent as the waxed area.

21. The greeting card of claim 9, wherein the decal has substantially the same areal extent as the waxed paper.

22. A method of making a greeting card for indicating a date, comprising:
providing a card;
disposing in or on the card a first set of information about an event occurring on at least one date;
providing a decal, the decal containing a second set of information corresponding to the first set of information;
disposing a second adhesive on a side of the decal opposite the side containing the second set of information; and
mounting the decal to the card via a first adhesive.

23. The method of making a greeting card of claim 22, wherein the disposing of the first set of information includes printing the first set of information on the card.

24. The method of making a greeting card of claim 22, further comprising disposing a waxed area on the card, wherein said mounting includes disposing the decal on the waxed area, and wherein the first adhesive is the same as the second adhesive.

25. The method of making a greeting card of claim 22, further comprising disposing a waxed paper on the card, wherein said mounting includes disposing the waxed paper on the card via the first adhesive.

26. The method of making a greeting card of claim 25, further comprising mounting the decal on the waxed paper via the second adhesive.

27. The method of making a greeting card of claim 22, wherein the second adhesive is a gummed substance.

28. The method of making a greeting card of claim 22, further comprising writing or printing at least one of the first information or the second information.

29. The method of making a greeting card of claim 22, further comprising encoding at least one of the first information or the second information in an aural form.

30. The method of making a greeting card of claim 22, further comprising drawing or picturing at least one of the first set of information or the second set of information.

31. The method of making a greeting card of claim 22, wherein at least one of the first adhesive or the second adhesive includes a gummed substance.

32. The method of making a greeting card of claim 22, further comprising folding the card into a bifold card.

33. The method of making a greeting card of claim 22, further comprising folding the card into a trifold card.

34. The method of making a greeting card of claim 29, further comprising disposing within the card, or the decal, or both, a memory and a speaker.

35. The method of making a greeting card of claim 34, further comprising disposing within the card, or the decal, or both, a microphone.

36. The method of making a greeting card of claim 22, further comprising disposing within the first set of information, the second set of information, or both, a date of the event.

37. The method of making a greeting card of claim 22, further comprising disposing within the first set of information, the second set of information, or both, a time or a location of the event.

38. The method of making a greeting card of claim 22, further comprising indicating a date of the event within the second set of information by shaping the decal in a definite pattern.

39. The method of making a greeting card of claim 38, wherein the definite pattern is an arrow.

40. The method of making a greeting card of claim 22, further comprising providing a decal having a dimension of less than about 1″.

41. The method of making a greeting card of claim 22, wherein the mounting the decal to the card includes inserting or friction-fitting the decal into a slot of the card.

42. The method of making a greeting card of claim 25, further comprising shaping the decal to have substantially the same areal extent as the waxed area.

43. The method of making a greeting card of claim 26, further comprising shaping the decal to have substantially the same areal extent as the waxed paper.
